(19) United States
(12) Patent Application Publication
(10) Pub. No.: US 2016/0056434 A1
(43) Pub. Date: Feb. 25, 2016

(54) MICROPOROUS SEPARATION MEMBRANE COMPRISING POLYPROPYLENE RESIN

(71) Applicant: HANWHA TOTAL PETROCHEMICAL CO., LTD., Seosan-si (KR)

(72) Inventors: Dae Ho PARK, Seoul (KR); Do Hoon LEE, Seosan-si (KR); Byoung Sun PARK, Seoul (KR)

(21) Appl. No.: 14/781,214

(22) PCT Filed: Feb. 25, 2014
(86) PCT No.: PCT/KR2014/001497

§ 371 Date: Sep. 29, 2015

(30) Foreign Application Priority Data
Apr. 15, 2013 (KR) 10-2013-0041036

(51) Int. Cl. H01M 2/16; H01M 10/0525

(52) U.S. Cl. CPC H01M 2/1653; H01M 10/0525

(57) ABSTRACT

Provided is a microporous separation membrane using a polypropylene resin, and more specifically, a microporous polymer separation membrane produced using a polypropylene resin, of which, at 230° C. under 2.16 kg, the melt index is 0.5 to 10 g/10 min., the polydispersity index is 5 or more, and the stereoregularity (isotactic index) is 94% or more.

### TECHNICAL FIELD

The present invention relates to a microporous separation membrane using a polypropylene resin, and more particularly, to a microporous separation membrane produced by including polypropylene, in which the melt index is 0.5 to 10 g/10 min., the polydispersity index is 5 or more, and the stereoregularity (isotactic index) is 94% or more.

### BACKGROUND ART

A microporous separation membrane is widely used in various fields, such as, a separation membrane for water treatment, and a medical dialysis device, and recently, is also applied as a separation membrane for a lithium ion battery. The separation membrane for a lithium ion battery is a porous thin film being between a cathode and an anode, and is used for facilitating the permeation of lithium cation in the processes of charging/discharging a battery. Generally, it is prepared with a polyolefin-based resin, such as, polypropylene and polyethylene, in terms of a cost, chemical resistance, tensile strength, and ion conductivity.

A microporous separation membrane using the polyolefin-based resin is produced using a dry process by a uniaxial elongation of the extruded polyolefin film, and a wet process including the extruding and biaxial elongation of the blend prepared of liquid paraffin/high density polyethylene (HDPE)/ultra high molecular weight polyethylene (UHMWPE), and then, removing the liquid paraffin using an organic solvent. Here, the wet process has some problems in terms of environmental and economic aspects because it uses liquid paraffin and an organic solvent. In the case of the dry process, as compared with the wet process, the process is simple, and thus, the economic aspect is advantageous, and also, since an organic solvent is not used, it is environmentally friendly. In order to produce a dry microporous polymer separation membrane, a polymer chain should be induced to be orientated in a machine direction (MD) in an extrusion preparation process, and thus, as illustrated in FIG. 1, it should be induced to crystallize a lamellae layer in the state of being oriented in a transverse direction (TD) and to be a laminated structure along the machine direction. Here, in FIG. 1, a refers to a lamellae crystallized layer and b refers to an amorphous layer. For this reason, the shear-induced crystallization should be induced in an extrusion process, and in order for the shear-induced crystallization, the production of optimum resin in the step of selecting a raw material should be decided first, in addition to the film processing conditions.

### DISCLOSURE

### Technical Problem

An object of the present invention is to provide a microporous separation membrane produced by using a polypropylene resin, which is easily used for forming a laminated structure prepared by laminating a lamellae layer to be vertical to a machine direction in a precursor before the step of forming pores through the elongation when a microporous separation membrane is produced using a dry process.

### Technical Solution

In order to achieve the object of the present invention, the microporous separation membrane according to the present invention is prepared by comprising a polypropylene resin that is a high stereoregular propylene-based homopolymer resin having the melt index of 0.5 to 10 g/10 min., the polydispersity index of 5 or more, and the stereoregularity (isotactic index) of 94% or more.

The polypropylene resin used in the present invention has preferably the melt index (MI) of 0.5 to 10 g/10 min. measured based on ASTM D1238. When the melt index is less than 0.5 g/10 min., the flowability of resin is reduced to decrease processability at the time of film extrusion processing. When the melt index exceeds 10 g/10 min., at the time of film extrusion processing, the melt viscosity is reduced, thereby not completely forming the orientation of polymer chain, and thus, the pores may not be properly formed at the time of elongation processing. For the present invention, the blend of high stereoregular propylene-based homopolymer resins having different melt indexes may be used, and also, within the range that can achieve the purpose of the present invention, a side chain-introduced propylene-based homopolymer resin may be included.

The polypropylene resin used in the present invention has preferably the polydispersity index (PI) of 5 or more, which is measured using a rotational viscometer (Rheometric Dynamic Spectrometer) through a rheological method. When the polydispersity index is less than 5, the laminated structure of lamellae that is the purpose of the present invention may not be easily formed at the time of film extrusion processing.

The polypropylene resin used in the present invention has preferably the stereoregularity index of 94% or more by a nuclear magnetic resonance pentad method. When the stereoregularity index of the polypropylene resin by the nuclear magnetic resonance pentad method is less than 94%, the degree of crystallization of the microporous film before being elongated that is the purpose of the present invention may not be sufficient, the laminated structure may not be properly formed, and also, the pores may not be easily formed. Here, the stereoregularity index by the nuclear magnetic resonance pentad method is calculated by measuring isotacticity in a pentad unit in a polypropylene molecule measured using ¹³C-NMR, and refers to the fraction of the propylene repeating unit being at the center of the chain being continuously meso-bound with five propylene monomer units. In detail, the isotacticity, that is, a stereoregularity index by a pentad method is measured as the area fraction of the meso binding peak (mmmm) in the whole absorption peak of the methyl carbon area of ¹³C-NMR spectrum. The detailed content about this is disclosed in the thesis of V. Busico, and the like (Prog. Polym. Sci. 26 443 (2001)).

A polymerization catalyst that is used for preparing the polypropylene resin used in the present invention may be a Ziegler-Natta catalyst or metallocene catalyst. The catalyst that can increase the stereoregularity index and can polymerize to be wide molecular weight distribution is preferable. As a polymerization catalyst for achieving the purpose of the present invention, a succinate-based catalyst may be preferably used. In the case of using a phthalate-based catalyst, the molecular weight distribution may be widely induced by changing the degree of polymerization for each of the polymerizations.

In the polymerization for preparing the polypropylene resin, a chain transfer agent, scavenger, or various additives may be used. In more detail, the propylene-based homopolymer may be formed by preparing a catalyst for propylene polymerization by reacting dialkoxy magnesium with a titanium compound and internal electron donor in the presence of an organic solvent, and then, reacting them with a monomer in the presence of alkyl aluminum and external electron donor along with the catalyst. For example, the catalyst system composed by selecting proper external electron donor and organic aluminum compound and the catalyst disclosed in Korean Patent Application Laid-Open Nos. 2006-0038101, 2006-0038102, 2006-0038103, and the like, and then, combining them may be used.

There are no detailed limitations about the polymerization method for the high stereoregular polypropylene resin, and the high stereoregular polypropylene resin may be polymerized through a bulk polymerization, a solution polymerization, a slurry polymerization, a gas phase polymerization, and the like, and any way of batch way or continuous is possible. In addition, these polymerization methods may be combined, and in terms of economical aspect, the continuous gas phase polymerization is preferable. In more detail, there may be a method for preparing a propylene-based polymer in the presence of a catalyst system through properly selecting the above-described catalyst component, organic aluminum compound, and external electron donor. Here, for polymerizing a propylene-based polymer part, in order to increase the degree of molecular weight distribution and increase the content of high molecular weight part, various polymerization batches are arranged in series for the polymerization of propylene homopolymer, and the degrees of polymerization for all the polymerization batches may be different from each other, and thus, the polymerizations may be performed in order.

The microporous separation membrane of the present invention may be prepared with a resin composition including the polypropylene resin and general additives. As the additives, within the range that can achieve the purpose of the present invention, there may be various additives, such as, a reinforcing agent, filler, thermal stabilizer, weather-proof stabilizer, an antistatic agent, a lubricant, a slip agent, dyes, and the likes. In addition, in order to secure long-term thermal and oxidation stability, an antioxidant is preferably added. The additives are not particularly limited as long as they are known in the prior art.

The method for preparing the resin composition is not particularly limited, and the method of preparing the polypropylene resin composition that is generally known as it is or the method that is properly modified may be used. The polypropylene resin and other additives may be freely selected and mixed according to the desired order without particularly order limitation. In other words, in detail, for example, the resin composition may be prepared by adding the polypropylene resin and other additives in the desired amounts into a mixer, such as, a kneader, roll, and Banbury mixer or a single/twin screw extruder, and then, blending these added raw materials using these devices.

The method of preparing the microporus separation membrane according to the present invention is not particularly limited, but preferably, the method includes (1) providing a precursor film by extrusion-processing the composition comprising the polypropylene resin, (2) annealing the precursor film, and (3) forming micropores by uniaxially elongating the annealed precursor film.

In the above step (1), for example, the resin composition may be melted in the temperature of 180 to 250° C. using a T die or a circular die using a single screw or twin screw extruder to form a precursor film, and in order to control the temperature of the discharged resin and making the film producing state to be good, air may be sprayed through an air knife, an air blower, or an air ring. A take-up roll is to be a certain rate, but preferably, the rate of 10 to 300 m/min. When the rate of the take-up roll is less than 10 m/min., the orientation of resin is not properly formed, and when it exceeds 300 m/min., the uniformity of the produced film may be low.

In the above step (2), the precursor film produced in the above step (1) may be annealed, for example, 130 to 160° C. for 10 min. to 1 hour, and at this time, after being annealed, the elastic recovery measured in a universal testing machine (UTM) should be 85% or more. When the elastic recovery of the annealed precursor film is less than 85%, there is a problem in that the pores may not be formed through the following elongation process. The elastic recovery is measured using a universal testing machine at room temperature (25° C.), but the annealed precursor film having a width of 15 mm is elongated at the elongation rate of 50 mm/min after starting at a grip distance of 50 mm (L₀), and immediately after performing the elongation by 100%, the length (L₁) at the point of being 0 of the residual stress is measured when again recovering it at the rate of 50 mm/min, and then, calculated using the following Equation.

ER(%)=(L₁−L₀)/L₀×100

In the above step (3), for example, the annealed precursor film may be uniaxially elongated by 10 to 70% at the low temperature of 0 to 80° C., may be uniaxially elongated by 50 to 250% after increasing the temperature to be 100 to 155° C., and then, may be cooled to obtain the film for a microporous separation membrane. Here, the size of pore, permeability, mechanical properties, and the like are determined through the degree of elongation at the low temperature and high temperature and the micro control of the high elongation temperature, and thus, there are no particularly optimum conditions.

### Advantageous Effects

When a precursor film is produced using the polypropylene resin according to the present invention, it is easy to produce a precursor film for producing a porous film through dry process, and also, a microporous separation membrane having excellent permeability can be effectively provided through extruding (extrusion), annealing, and elongating the precursor film (stretching process).

In addition, the microporous separation membrane produced by using the polypropylene resin according to the present invention can be usefully applied for a separation membrane for a lithium ion battery.

### DESCRIPTION OF DRAWINGS

FIG. 1 is a view illustrating the structure, in which a lamellae layer is vertically laminated to a machine direction in the precursor (‘film’) before forming pores through elongation (a refers to a lamellae crystallized layer and b refers to an amorphous layer).

FIG. 2(a) is a view illustrating a diffraction pattern in 2D WAXS analysis of Example 1.

FIG. 2(b) is a view illustrating a diffraction pattern in 2D WAXS analysis of Comparative Example 2.

FIG. 3(a) is a view illustrating a 2^{nd} order peak in the meridian of 2D SAXS of Example 1.

FIG. 3(b) is a view illustrating a 2^{nd} order peak in the meridian of 2D SAXS of Comparative Example 2.

FIG. 4(a) is a view illustrating the pore distribution in the microporous polymer separation membrane of Example 1.

FIG. 4(b) is a view illustrating the pore distribution in the microporous polymer separation membrane of Comparative Example 2.

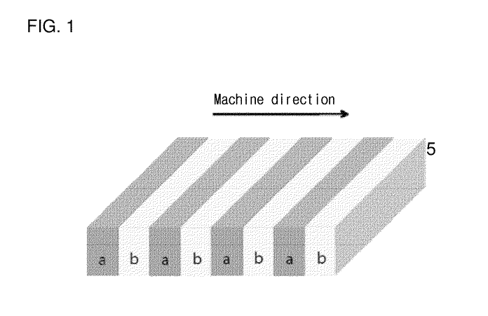

### MODES OF THE INVENTION

Hereinafter, the present invention will be described in more detail with reference to the following Examples, but the range of the present invention is not limited to the following Examples.

Physical Property Measurement/Evaluation Items, and Test Method Thereof

The methods of measuring various physical properties for each of Examples and Comparative Examples are as follows.

(1) Melt Index (MI)

It was measured at 230° C. under the load of 2.16 kg based on ASTM D1238. (2) Polydispersity Index (PI)

The polydispersity index was measured using the crossover modulus (Gc) that is an intersection point of a storage modulus and a loss modulus through a rheological method from the following Equation.

$$P I - \frac{{10}^{6}}{{G}_{C} ( \frac{dynes}{{cm}^{2}} )} = \frac{{10}^{5}}{{G}_{C} ( Pa )}$$

(3) Stereoregularity Index

It was measured as an area fraction of meso binding peak (mmmm) in the whole absorption peak of methyl carbon area in ¹³C-NMR spectrum of polypropylene.

(4) Thickness

The thickness of film was measured based on ASTM D374.

(5) Tensile Strength

It was measured with a universal testing machine (UTM) manufactured by Instron based on ASTM D3763.

(6) Elastic Recovery (ER)

It was measured using a universal testing machine (UTM) at room temperature (25° C.), but the annealed precursor film having a width of 15 mm was elongated at the elongation rate of 50 mm/min after starting at a grip distance of 50 mm (L₀), and immediately after performing the elongation by 100%, the length (L₁) at the point of being 0 of the residual stress was measured when again recovering it at the rate of 50 mm/min, and then, calculated using the following Equation.

ER(%)=(L₁−L₀)/L₀×100

(7) Permeability (Gurley)

The time (second) for passing 100 mL of air through 1 inch microporous film under the certain pressure of 4.8 inch H₂O at room temperature was measured according to Japanese Industrial Standard (JIS) Gurley measuring method.

(8) Porosity

The porous film was cut to be a length and width of 50 mm, and then, the thickness and weight thereof was measured to calculate a density. In other words, the volume was measured as the width×the length×the thickness, and the density (ρ₁) was calculated by dividing the measured weight by the volume. The porosity (P) was calculated with the following Equation by the true density (ρ₀) and the film density (ρ₁) above measured. The true density of the polypropylene confirmed in the present invention was 0.905 g/cm³.

P(%)=(ρ₀−ρ₁)/ρ₀×100

### Examples and Comparative Examples

The polypropylene resins used in Examples and Comparative Examples are summarized in the following Table 1. As the compositions listed in the following Table 2, both of the polypropylene resin and additive (i-1010, i-168, and calcium stearate (CaSt) as an antioxidant) were added at one time in a twin screw extruder (32 mm twin extruder, manufactured by HANKOOK E.M. Ltd.), and then, were blended to prepare a polypropylene resin composition.

TABLE 1

| | Propylene- | Propylene- | Propylene- | Propylene- | Propylene- | Propylene- |
|---|---|---|---|---|---|---|
| | based | based | based | based | based | based |
| | homopolymer 1 | Homopolymer 2 | homopolymer 3 | homopolymer 4 | homopolymer 5 | homopolymer 6 |
| Melt index | 3.1 | 3.3 | 3 | 3.2 | 0.2 | 15 |
| (g/10 min.) | | | | | | |
| PI | 6.7 | 9.8 | 4.3 | 6.2 | 6.2 | 6.2 |
| Stereoregularity | 96 | 95 | 96 | 91 | 95 | 97 |
| (%) | | | | | | |

Using the polypropylene resin composition, the extrusion was performed at 200° C. through a twin screw extruder (L/D 40) having a T die manufactured by Dr. Collin (in the case of Comparative Example 3, the extrusion was not properly performed in this condition, and thus, was performed at 240° C.). At this time, the film was prepared at the die gap of 2.0 mm, the take-up rate of 30 m/min., and the cast roll temperature of 80° C. Each of the films was annealed at 155° C. for 30 min, and then, was uniaxially elongated by 25% at 30° C. and 175% at 150° C. in MD to be the total of 200% elongation.

The results of measuring the physical properties of the films prepared as above are listed in the following Table 2.

TABLE 2

| | | | | Comparative | Comparative | Comparative | Comparative |
|---|---|---|---|---|---|---|---|
| | | Example 1 | Example 2 | Example 1 | Example 2 | Example 3 | Example 4 |
| Resin | Propylene- | 100 | | | | | |
| Composition | based | | | | | | |
| (part by | homopolymer 1 | | | | | | |
| weight) | Propylene- | | 100 | | | | |
| | based | | | | | | |
| | homopolymer 2 | | | | | | |
| | Propylene- | | | 100 | | | |
| | based | | | | | | |
| | homopolymer 3 | | | | | | |
| | Propylene- | | | | 100 | | |
| | based | | | | | | |
| | homopolymer 4 | | | | | | |
| | Propylene- | | | | | 100 | |
| | based | | | | | | |
| | homopolymer 5 | | | | | | |
| | Propylene- | | | | | | 100 |
| | based | | | | | | |
| | homopolymer 6 | | | | | | |
| | i-1010 (ppm) | 500 | 500 | 500 | 500 | 500 | 500 |
| | i-168 (ppm) | 500 | 500 | 500 | 500 | 500 | 500 |
| | CaSt (ppm) | 500 | 500 | 500 | 500 | 500 | 500 |
| physical | Thickness | 24 | 24 | 24 | 24 | | 24 |
| property of | (micron) | | | | | | |
| Precursor | Elastic | 94 | 95 | 87 | 83 | | 81 |
| | recovery (%) | | | | | | |
| Physical | Thickness | 20 | 21 | 14 | 11 | | 12 |
| property of | (micron) | | | | | | |
| elongation | Permeability | 192 | 168 | 910 | 3200 | | 3500 |
| film | (sec/100 mL) | | | | | | |
| | Porosity (%) | 53 | 55 | 12 | 6 | | 3 |

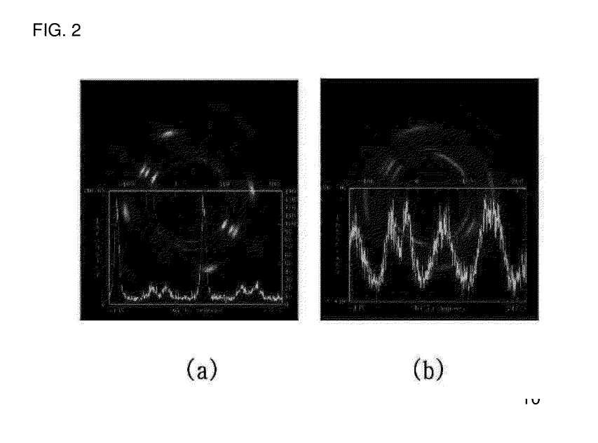

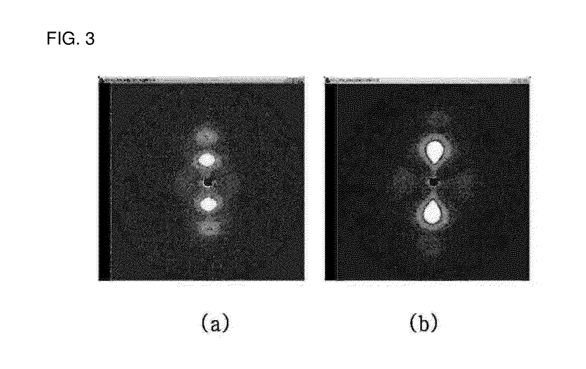

As listed in Table 2, Examples 1 and 2 satisfied the conditions of the present invention, and thus, the precursor film had high elastic recovery. In the case of Example 1, for the 2D WAXS analysis (FIG. 2(a)), the diffraction pattern was clearer, and for the 2D SAXS analysis (FIG. 3(a)), 2^{nd} order peak was confirmed in the meridian. Therefore, it was confirmed that the orientation of lamellae layer was properly formed.

Comparative Example 1 exhibited low polydispersity index, and the elastic recovery was lower than that of Example 1.

Comparative Example 2 exhibited low stereoregularity, and like Comparative Example 1, the elastic recovery was lower than that of Example 1. For the 2D WAXS analysis (FIG. 2(b)), as compared with Example 1, the diffraction pattern was more dispersed, and for the 2D SAXS analysis (FIG. 3(b)), a 2^{nd} order peak was not confirmed in the meridian.

Comparative Example 4 exhibited high melt index, and like Comparative Examples 1 and 2, the elastic recovery was lower than that of Example 1.

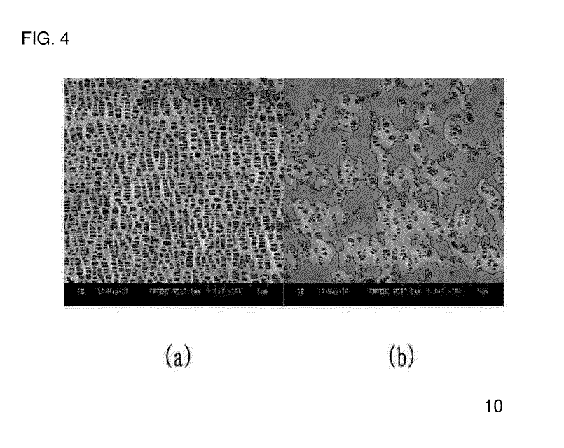

As the result of elongating each of the precursor films, in the case of Example 1, the decrease in the thickness was relatively few as compared with the state before the elongation, and the Gurley value was low, thereby exhibiting excellent permeability. In addition, it was confirmed that the porosity was high. Furthermore, it was confirmed that as illustrated in FIG. 4(a), the pores were uniformly distributed on the overall film.

Comparative Examples 1, 2, and 4 exhibited the considerable decrease in the thickness after being elongated, and it was confirmed that due to high Gurley value, the permeability was low and porosity was low. In addition, as illustrated in FIG. 4(b), the pores were non-uniformly distributed.

Comparative Example 3 exhibited low melt index, and the melt flowability of the resin was low, thereby unstably discharging the resin in the extrusion process. Therefore, good precursor film for preparing a porous film to be desired in the present invention could not be obtained.

1. A microporous separation membrane prepared by comprising a polypropylene resin, wherein the polypropylene resin is a propylene homopolymer, of which, at 230° C. under 2.16 kg, the melt index is 0.5 to 10 g/10 min., the polydispersity index is 5 or more, and the stereoregularity is 94% or more.

2. The microporous separation membrane of claim 1, wherein the microporous separation membrane is prepared by preparing a precursor film through extruding a resin composition comprising the polypropylene resin, annealing the precursor film, and then, uniaxially elongating the annealed precursor film.

3. The microporous separation membrane of claim 2, wherein an elastic recovery of the precursor film, which is measured after annealing the precursor film at 130 to 160° C. for 10 min. to 1 hour, is 85% or more.

4. The microporous separation membrane of claim 2, wherein the elongation is performed by elongating at a low temperature, 0 to 80° C., and then, elongating at a high temperature, 100 to 155° C. to induce a pore production.
